(19) United States
(12) Patent Application Publication
(10) Pub. No.: US 2008/0270218 A1
(43) Pub. Date: Oct. 30, 2008

(54) System and Method for Obtaining Pertinent Real-Time Survey Evidence

(75) Inventors: Graham John Scott, Western Australia (AU); Michael Roman Kasatchkow, Western Australia (AU)

Correspondence Address: HOFFMAN WASSON & GITLER, P.C;CRYSTAL CENTER 2, SUITE 522, 2461 SOUTH CLARK STREET, ARLINGTON, VA, 22202-3843, US

(73) Assignee: YOU KNOW ? PTY LTD, Burrendah (AU)

(21) Appl. No.: 11/579,496

(22) PCT Filed: May 11, 2005
(86) PCT No.: PCT/AU05/00666

§ 371 Date: Nov. 20, 2007

(30) Foreign Application Priority Data
May 11, 2004 (AU) 2004902477

(51) Int. Cl. G06F 17/30

(52) U.S. Cl. 705/10

(57) ABSTRACT

A system for conducting a survey to obtain real-time survey evidence. It has a host server (12), a questions database (24) associated with the host server (12), and comprising records representing a survey, each record comprising a question with associated possible answers. A data acquisition device (14) to receive survey questions with associated possible answers and operable by an interviewee to select a response from the possible responses for a question and transmit the response for the question to the host server (12). A responses database (26) associated with the host server to store responses to the questions received by the host server (12) in which the responses are associated with the survey.

### FIELD OF THE INVENTION

The present invention relates to a system and method for obtaining pertinent real-time survey evidence. While this invention will be described in the context of market survey evidence, the invention is not limited to such surveys and can be used for other surveys. One example of another survey for which the invention may be used, for example, is a survey of political opinions.

### BACKGROUND ART

The following discussion of the background of the invention is intended to facilitate an understanding of the present invention. However, it should be appreciated that the discussion is not an acknowledgement or admission that any of the material referred to was published, known or part of the common general knowledge of the person skilled in the art in any jurisdiction as at the date of the application.

Marketing organisations typically undertake surveys to obtain information from members of the general populace. Such surveys are undertaken by the marketing organisation on behalf of clients. Examples of how such surveys are conducted include:
(i) placing surveys in households for completion and return by one or more occupants;
(ii) having a representative physically stationed in a high pedestrian traffic area and engaging passers by in a survey; or
(iii) having a representative telephone households to speak to one or more of the occupants,

All of these have inherent problems.

Problems associated with the first-identified example include:
the household occupant/s is not supervised during completion of survey;
the household occupants may improvise answers due to misperception; and
the household occupant/s may not meet the presumed demographic criteria that are desired for the survey.

In the case of the second example, the problems include:
a the representative has a degree of control over who is selected to complete the survey—this may compromise the randomness of the cross-section of passers by engaged to participate in the survey;
a people who are interested in completing the survey will seek out the representative whilst those who are not will tend to avoid the representative—this may, again, compromise the randomness of the cross-section of passers by engaged to participate in the survey; and
the sited position of the representative may be inadequate to obtain an accurate reflection of the opinion of the general populace; for example, siting a representative in the middle of a pedestrian mall within a city will bias the results of a survey towards city workers and city shoppers.

In the case of the third example, the problems include:
again, the people surveyed may not be an adequate cross-section of the general populace in the community;
the people who agree to undertake the survey may do so in an irritated state attributable to the interruption caused by the telephone call, which may affect their responses and thereby the survey results; and
typically, the survey can be conducted only during legislated hours and, in some jurisdictions, people may be able to exclude themselves from being contacted by such representatives.

In all of the previously described examples, cumulative results can not be presented on a real-time basis.

### DISCLOSURE OF THE INVENTION

Throughout the specification, unless the context requires otherwise, the word “comprise” or variations such as “comprises” or “comprising”, will be understood to imply the inclusion of a stated integer or group of integers but not the exclusion of any other integer or group of integers.

In accordance with a first aspect of the present invention there is provided
a system for conducting a survey to obtain real-time survey evidence comprising
a host server,
a questions database associated with the host server and comprising records representing a survey, each record comprising a question with associated possible answers,
a data acquisition device to receive survey questions with associated possible answers and operable by an interviewee to select a response from the possible responses for a question and transmit the response for the question to the host server, and
a responses database associated with the host server to store responses to the questions received by the host server in which the responses are associated with the survey.

In accordance with a second aspect of the present invention there is provided
a method of conducting a survey to obtain real-time survey evidence using a host server and a data acquisition device comprising
allocating a survey to an interviewee from a questions database associated with the host server,
presenting questions with possible responses, that comprise the survey, to the interviewee by the data acquisition device,
receiving the interviewee responses via the data acquisition device at the host server,
storing the interviewee responses in a responses database in a record, and
associating the record with the survey.

In one embodiment of the present invention, the host server and data acquisition device act in unison to:
obtain demographic data (if any) from an interviewee using the data acquisition device;
compare the demographic data with demographic data for each survey stored in a questions database associated with the host server and thereby select a survey for the interviewee to complete;
present the questions and responses to the interviewee, and receive the interviewee's responses, using the data acquisition device, where each question/response combination determines the next question and responses to be presented to the interviewee using the data acquisition device; and
storing the responses provided by the interviewee in a response database in a record and associating that record with the selected survey.

If the interviewee does not disclose any demographic data, then the interviewee can participate only in surveys designated as open to all.

As the survey structure allows for a two-dimensional question/response structure, it is possible for surveys to be interrelated by use of common question/responses. Further, demographic criteria, in conjunction with the question/response combination, can be used to determine the next question/response to be presented to the interviewee using the data acquisition device. Thus, a three-dimensional survey structure can be implemented.

The data acquisition device is, in its preferred embodiment, A5 in size and includes a touch screen display unit. The data acquisition device may also include a routine for translating question/response combinations to allow non-English speaking interviewees to participate in the surveys. Data acquisition device may further include background illumination means to facilitate use in low-light environments. Yet further, the data acquisition device may include routines for adjusting the text size of questions/responses to facilitate use of the data acquisition device by visually impaired people.

Ideally, the data acquisition device is located in a captive environment, such as a transportation vehicle or waiting room. In an effort to obtain a survey population including the best cross-sectional view of a community possible, ideally the data acquisition device is located in a taxi.

Information, such as time of completion of survey and location the survey was completed may also be captured and transmitted to the host server. In the case of surveys conducted in a transportation vehicle, the location where the interviewee was collected from may also be captured and transmitted to the host server.

Surveys can be limited in both duration and number of questions. Surveys can also be added to the system on a real-time basis and specified to be available to interviewees for a predefined time period (thus allowing situations such as a day-long poll on a political issue). The demographic profile for each survey can also be modified on a real-time basis—either as an automatic feature of the system upon an interviewee completing a survey or as a configuration tool of a party responsible for the survey.

Selection of the survey may occur on a sequential, random or prioritised basis. If the interviewee agrees to participate in multiple surveys, the system operates to ensure that the interviewee does not complete the same survey twice.

The system may also include an external computer connection. The external computer connection can be used by the party responsible for the survey to access the raw data in the response database or obtain reports on such raw data. In the latter situation, the raw data reports may be based on a gridding system and/or on the basis of such factors as time priority, sample size or complexity of results analysis.

The connection between the system and external computer may be by means of a communication network, such as the Internet. Secure communication procedures may be implemented between both data acquisition device and host server and between host server and external computer.

The system may also be integrated with a loyalty or rewards scheme.

### BRIEF DESCRIPTION OF THE DRAWINGS

The present invention will now be described, by way of example, with reference to the drawings, wherein:—

FIG. 1 is a schematic representation of an embodiment of a system for obtaining pertinent real-time survey evidence in accordance with the present invention;

FIG. 2 is a flow diagram showing the operation of an embodiment of the system of the present invention; and

FIG. 3 is an embodiment of a screen shot depicted on the screen display of the data acquisition device.

### BEST MODE(S) FOR CARRYING OUT THE INVENTION

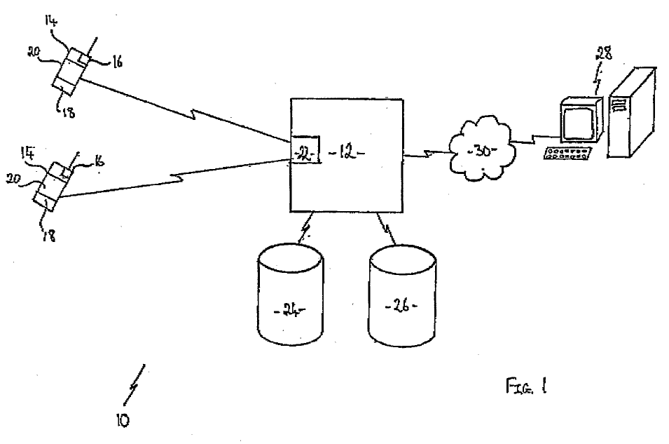

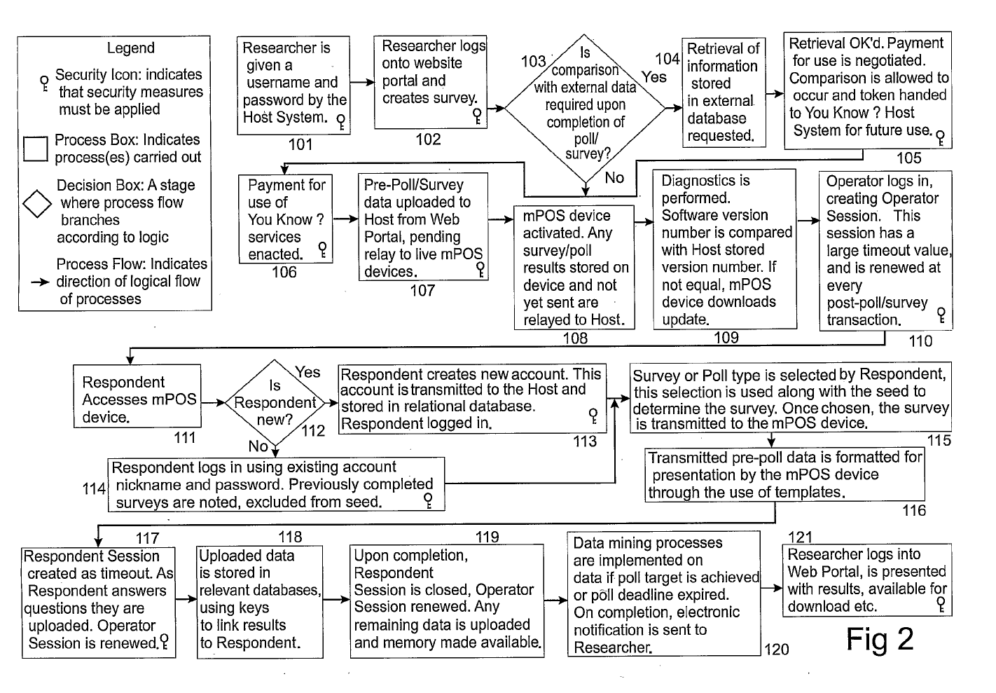

The following description is with reference to FIG. 1 of the drawings which shows a representation of an embodiment of a system 10 in accordance with the present invention. FIG. 2 shows a flow diagram of an embodiment of the processes of the present invention. The processes shown in FIG. 2 are identified as “[Steps]” at the corresponding locations in the description that follows of the present invention. The flow diagram shown in FIG. 2 uses the term “Researcher” to identify the organisation for whom the survey is being undertaken; the terms “You Know ?” and “Host” to identify the organisation controlling the implementation and operation of the system; the term “Operator” to identify the party interacting with the interviewee, e.g. in the example described in the embodiment this is the taxi driver; the term “Respondent” is the interviewee.

In accordance with a first embodiment of the invention there is a system 10 for obtaining pertinent real-time survey evidence.

The system 10 comprises:
a host server 12; and
at least one data acquisition device 14.

Each data acquisition device 14 is a small data processing unit comprising:
a transmitter 16;
a processor 18 (with associated memory means); and
a touch screen display unit 20.

It is preferable that for ease of handling and data input, the data acquisition device is substantially A5 in size.

The host server 12 comprises, or has associated therewith, a transmitter 22, a questions database 24 and a results database 26. The host server 12 and each data acquisition device 14 communicate with each other by means of transmitters 16, 22. The host server 12 is also able to communicate with external computers 28 via a communication network 30, such as the Internet.

Questions database 24 comprises a number of records grouped into sets and each such set represents a survey. Each survey includes details of the demographics of potential interviewees to be included in the survey. In the case of surveys open to all, the demographic information is set to reflect that the availability of the survey is not dependent on the demographics of the interviewees. The survey also includes details of each question to be presented in the survey and the possible responses available for that question. Each of the questions, with possible responses, are stored as separate records in the questions database 24. Each survey consists of a set of such records

In one embodiment, question/actual response combinations can be used to direct a survey towards other questions. That is, the next question presented to the interviewee is dependent upon the previous response actually provided by the interviewee that is obtained at the host server 12. In this manner, a survey may be tree like in nature rather than linear. In a further embodiment, different surveys having related questions can be interlinked using the same initial branches or end branches (as may be appropriate). In any case, a survey is limited as to the maximum number of questions that may be presented to a potential interviewee.

An embodiment of the system will now be described in use.

The at least one data acquisition device 14 is located in a captive environment. A captive environment is one where a potential interviewee has a limited choice of activities that they can do with their time. Examples of captive environments in which the data acquisition device 14 may preferably be located include:
taxis;
aeroplanes;
buses; and
waiting rooms.

In one preferred examples the captive environment is a taxi, as the different geographical areas the taxi may travel through can provide a better indication of popular opinion amongst a broad cross-section of the general populace in the community.

Upon entering the captive environment, the interviewee is asked by an authorised representative [Step 110] (for example the taxi driver in the case that the captive environment is a taxi) whether the potential interviewee (the passenger in the taxi) wishes to participate in a survey. If so, the interviewee is provided with the data acquisition device 14. [Step 111]

The data acquisition device 14 first operates to present a series of questions to the interviewee to determine the demographics of the interviewee. [Steps 112, 113] For example, the questions may pertain to such factors as:
age;
gender;
income;
ethnic background;
general area of residence (e.g. by postcode).

All demographic questions are stated to be optional. If the interviewee does not answer any demographic question, the interviewee can then participate only in surveys that are open to all (as previously hereinbefore described).

The interviewee responds to each question by selecting his or her response from the possible responses that are displayed on touch screen display unit 20. Once all of the series of demographic questions have been answered by the interviewee, the processor 18 operates to package the responses as data and transmits the data to the host server 12 using transmitter 10.

Once the interviewee has completed the demographic questions, the responses of the interviewee may be stored by the host server 12. In this way, when the interviewee next uses the system 10 to participate in surveys, the interviewee may log in to the system with a “nicknamee” and password. Thus, in effect, the interviewee establishes an account on the host server 12. This also enables surveys previously completed by the interviewee to be noted and excluded so that the interviewee does not again receive those surveys. [Step 114]

The survey given to the interviewee is based on a comparison of the demographic data, pertaining to the interviewee, received by the host server 12 from the data acquisition device 14 and the demographic criteria set for each survey [Steps 115, 116]. The host server 12 then selects the first matching suitable survey and the first question to be displayed to the interviewee from the questions database 24. The first question for that survey (along with the choice of answers for the questions i.e. the possible responses) is then transmitted to the data acquisition device 14, that the interviewee is operating, using transmitter 22. The host server 12 also operates to transmit information identifying the survey the interviewee is undertaking to the data acquisition device 14 using transmitter 22.

Upon receiving this first question, the processor 18 initiates a timer routine and a counter routine. The processor 18 also operates to display the first question, and the choice of answers applicable to the question, using the touch screen display unit 20. The interviewee can then choose his/her response from the possible responses using the touch screen display unit 20.

Upon identifying that the interviewee has chosen a response using the touch screen display unit 20, the processor 18 packages data identifying the answered question and the answer chosen as the response by the interviewee, and transmits this data package to the host server 12 using transmitter 16. [Step 117]

The host server 12 processes the data package and stores the interviewee's response (or a representative identifier of such a response) in results database 24. [Step 118] A repetitive procedure then commences whereby the host server 12 further processes the data package to determine the next question. That “next” question and its possible responses are then transmitted to the data acquisition device 14 using transmitter 22. The processor 18 then checks the timer routine. If the timer routine has reached zero (i.e. indicating that the maximum time for which the survey should run has been exceeded), the available information is retrieved and transmitted, along with an indicator representing that the interviewee has not completed the survey in full due to lack of time.

If the timer routine has not reached zero, the processor 18 then decrements the counter routine. As above, the processor 18 then operates to display the newly received question, and the choice of answers applicable to the question, using the touch screen display unit 20. The interviewee can then choose the appropriate response using the touch screen display unit 20. This is transmitted to the host server as a data package as hereinbefore described.

Upon transmitting a response, the processor 18 operates to check the counter routine value. If the counter routine value is not zero, the above procedure repeats. However, if the counter routine value is zero, i.e. the survey has been completed, the interviewee is asked, by means of touch screen display unit 20, whether he/she wishes to participate in another survey. The time in which the interviewee may respond to this request is limited. At the end of the time limit, the processor 18 operates to transmit the response provided to the last question asked to the host server 12 using transmitter 16.

If the interviewee has indicated that he/she wishes to participate in another survey, the interviewee's demographic details are again transmitted to the host server 12 using transmitter 16 along with identifying details of the surveys that have previously been undertaken by the interviewee. In this manner, the interviewee can be spared from completing the same survey twice. Instead, the interviewee is given the next suitable survey based on his/her demographics. If the interviewee has indicated that he/she does not wish to participate in another survey, the interviewee's demographic information is cleared from memory and the touch screen display unit 20 defaults to display a generic splash screen. [Step 119]

In an alternative embodiment, the questions presented to the interviewee, via the data acquisition device 14, by the host server 12 are preset for a particular survey, whereby the next question presented to the interviewee is not dependent upon the response provided by the interviewee to the previous question. In this embodiment, the interviewee answers all of the questions in the survey by selecting his/her desired response from the possible responses. Once the interviewee has completed the survey, the selected responses of the interviewee are packaged by the processor 18 into data identifying the answered questions and the answers chosen as the responses by the interviewee and all of these are transmitted as a single data package to the host server 12 using the transmitter 16.

In the embodiment hereinbefore described, the interviewee provides demographic data which is transmitted to the host server 12. The host server 12 uses the demographic data to select the next suitable survey for that interviewee based on the demographic data provided. However, in an alternative embodiment, no demographic data is provided by the interviewee. In such an embodiment, upon the host server 12 receiving a transmission from the data acquisition device 14 that an interviewee is ready to receive a survey, the host server 12 selects the next survey suitable for non-demographic interviewees and transmits this to the data acquisition device 14. The interviewee then selects his/her responses from the possible responses for each question as hereinabove described. In the case of the interviewee not providing any demographic data, the system may nevertheless operate by the next question being dependent upon the previous response provided by the interviewee, or alternatively, the questions in the survey are preset and are independent of the response provided by the interviewee to the previous question.

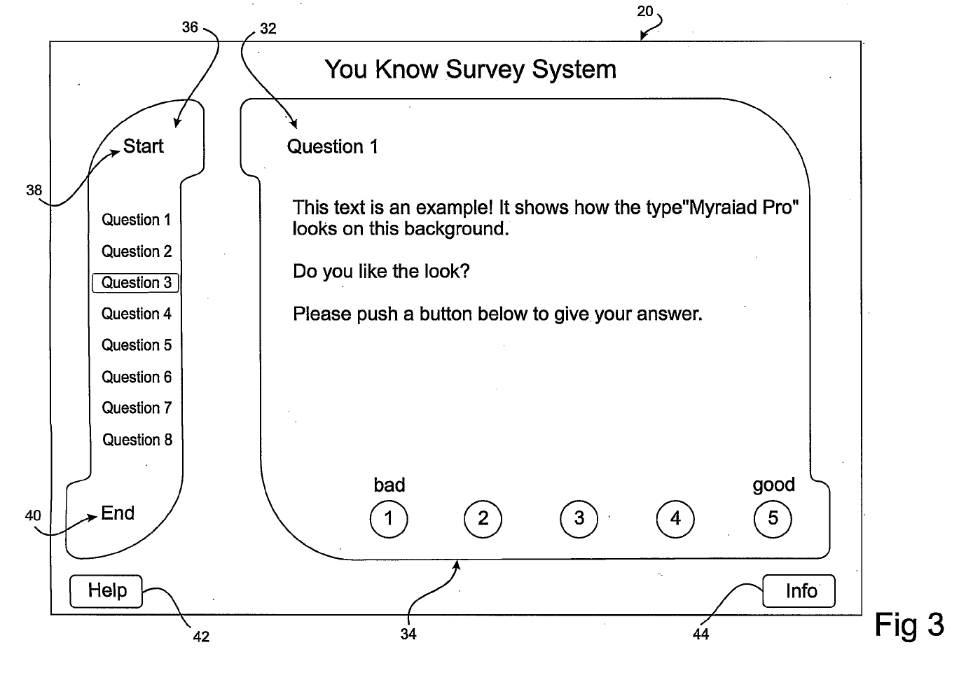

FIG. 3 shows an embodiment of a screen shot of the touch screen display unit 20 of the data acquisition device 14. The screen shot presents a question 32 to the interviewee. Possible responses are displayed at the bottom of the screen shot by way of the numbered display buttons 34 labelled 1-5. The interviewee selects the response he/she desires to make to the question by pressing the appropriate screen shot button 34 (1-5). A menu 36 is provided at the left side of the screen shot. The menu 36 lists the questions, 8 in the screen shot shown, and also has “start” and “end” buttons 38 and 40, respectively, that the interviewee can press to start and end the survey. A “help” button 42 and an “info” button 44 are also provided. The screen shot shown in FIG. 3 is an example of how the information can be set out on the touch screen display unit 20. Other arrangements to display the information may, alternatively, be employed.

Using an external computer 28, the party responsible for the survey can view the data stored in results database 26 at any time by connecting to the host server 12 using communication network 30. This information can be presented in a variety of formats as desired by the party responsible for the survey. [Stop 120] In this manner, not only can the party responsible for the survey obtain pertinent results (by specifying the demographic criteria for potential interviewees), but they can also view such results in real-time, [Step 121]

Steps 101 to 104 shown in FIG. 2 illustrate preliminary processes whereby the Researcher initially engages the Host system so as to use the services provided by the Host system to have surveys conducted on its behalf. Steps 105 and 106 represent processes whereby the Researcher is able to arrange for payment of the services to be provided. Step 107-109 represent processes whereby the preliminary data is uploaded to the Host from the web portal and ensuring that the data acquisition device (also referred to as the “mPOS device”) is functioning and able to receive and transmit data.

Furthermore, using the above system 10, human intervention is limited, if not eliminated. Thus, the inherent problem of human need to tinker with data is also limited, if not eliminated.

It should be appreciated by the person skilled in the art that the present invention is not limited to the embodiments described and that variations and modifications thereon fall within its scope. In particular, further embodiments of the above system may include the following features and/or modifications:
The system 10 may be implemented in conjunction with a loyalty or rewards scheme. The loyalty or rewards scheme may be interwoven in place of a question in a survey. Alternatively, the loyalty or rewards scheme may be activated on completion of a survey. The loyalty or rewards scheme may be operated by the system operator or by the party responsible for the survey concerned.
The party responsible for the survey may specify further limitations on potential interviewees. For example, if the party responsible for the survey wishes to obtain the views of a set number of people in each demographic category specified, the system 10 can be modified to update the demographic profile of the survey to reflect this wish. In this manner, once views from the desired number of people in a demographic category have been received, the demographic details associated with the survey may be changed to remove that demographic category as potential interviewees.
Surveys may be included on a real-time basis. Furthermore, selection of surveys for completion by the interviewee may be done on a random or prioritised basis (rather than the first come, first served basis described above). Surveys may also be limited in time (i.e., interviewees are only able to participate in the survey within a set time period).
The data acquisition device 14 may be adapted to include facilities to satisfy particular demographics or captive environments. For instance, the data acquisition device 14 may be able to translate questions into other languages, provide background illumination for low light areas and increase the size of text to assist people of lower visual ability.
The information displayed to the party responsible for the survey using external computers 28 may be presented based on the results of a unique gridding system. The answer given for each question determines the next question; this is further filtered by the demands of the particular clients needs and the demographic profile of the respondent. This aspect of the process is thus response driven and through invention, seeks the most productive pathways, to optimise the quantity of all client questions served by any one answer. The invention itself, rather than human intervention, is the source of the electronically automated decision making process. Alternatively, or cumulatively, the information may be presented on the basis of such factors as time priority, sample size or the complexity of results analysis.
Questions may have demographic criteria associated with them, such that transfer from question to question may be based on demographic criteria in addition to the question/answer combination. In this way, any answer may apply to any number of surveys.
Data acquisition devices 14 may be adapted to provide time stamp and location details to the host computer 12 for further data analysis. In the case of transportation vehicles, the ability to provide location details may be extended to include information as to the location at which the interviewee was collected.
The data acquisition devices 14 may be merely dumb slaves, with such functions as the timer routine, counter routine, and questions for obtaining demographic information from the interviewee controlled by the host computer 12.
The communications that occur between data acquisition device 14, host server 12 and external computers 28 may all be secure communications. This may include the use of cryptographic techniques.
Where dealing with large surveys, either in geographical terms or in terms of potential sample size, host server 12 may take the form of a cluster of servers that intercommunicate with one another—each server being separately located to provide faster data transmission of questions, etc. to the interviewee
Data acquisition devices 14 may be located in captive environments other than those mentioned above.

What is claimed is:

1. A system for conducting a survey to obtain real-time survey evidence comprising
a host server,
a questions database associated with the host server and comprising records representing a survey, each record comprising a question with associated possible answers,
a data acquisition device to receive survey questions with associated possible answers and operable by an interviewee to select a response from the possible responses for a question and transmit the response for the question to the host server, and
a responses database associated with the host server to store responses to the questions received by the host server in which the responses are associated with the survey.

2. The system according to claim 1, wherein the system further comprises at least one external computer connection to provide access to data in the responses database via an external computer.

3. The system according to claim 1 wherein the data acquisition device comprises a touch screen display to display questions and possible answers to the interviewee and to allow the interviewee to input selections using the data acquisition device.

4. The system according to wherein the data acquisition device comprises keys to permit the interviewee to input selections using the data acquisition device.

5. A method of conducting a survey to obtain real-time survey evidence using a host server and a data acquisition device comprising
allocating a survey to an interviewee from a questions database associated with the host server,
presenting questions with possible responses, that comprise the survey, to the interviewee by the data acquisition device,
receiving the interviewee responses via the data acquisition device at the host server,
storing the interviewee responses in a responses database in a record, and
associating the record with the survey.

6. The method according to claim 6, wherein the method further comprises
receiving the interviewee responses for all the questions in the survey as a single data package.

7. The method according to claim 5, wherein the method further comprises
receiving each interviewee response for a respective question in the survey as a single data package and basing the next question to be presented to the interviewee on the response received from the interviewee to the previous question presented to the interviewee.

8. The method according to claim 5 wherein the method further comprises
prior to allocating a survey to an interviewee, obtaining demographic data from the interviewee using the data acquisition device,
comparing the obtained demographic data with demographic data associated with each survey stored in the questions database, and
selecting the survey to be allocated to the interviewee based on the comparison made of the obtained demographic data and the associated demographic data.

9. The method according to claim 5 wherein the method further comprises
transmitting the survey completion time to the host server from the data acquisition device.

10. The method according to claim 5 wherein the method further comprises transmitting the location of the survey completion to the host server from the data acquisition device.
